(19) United States
(12) Patent Application Publication
(10) Pub. No.: US 2018/0314698 A1
(43) Pub. Date: Nov. 1, 2018

(54) MEDIA SHARING BASED ON IDENTIFIED PHYSICAL OBJECTS

(71) Applicant: GICSOFT, Inc., Duluth, GA (US)

(72) Inventor: Igor Babushkin, Johns Creek, GA (US)

(21) Appl. No.: 15/498,571

(22) Filed: Apr. 27, 2017

(51) Int. Cl. G06F 17/30

(52) U.S. Cl. CPC G06F 17/30047; H04L 63/104; G06F 17/30864; G06F 17/30038

(57) ABSTRACT

Disclosed are various embodiments for sharing media files based on physical objects identified within the media file. To begin, a computing device receives a first media file from a client device. The computing device then identifies an object present in the first media file. Subsequently, a search for a second media file associated with the object identified in the first media file is executed. The second media file is then sent to the client device.

### BACKGROUND

Searching for data often relies on a user's knowledge of the data to be searched for and the user's ability to describe the data accurately. For example, a user searching for information about a tool may be required to know the name of the tool, the manufacturer of the tool, the purpose of the tool, and other data about the tool. Moreover, a user may not be able to readily share data they are aware of regarding an object with other users.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered by a client according to various embodiments of the present disclosure.

FIG. 2 is a pictorial diagram of an example user interface rendered by a client according to various embodiments of the present disclosure.

FIG. 3 is a pictorial diagram of an example user interface rendered by a client according to various embodiments of the present disclosure.

FIG. 4 is a pictorial diagram of an example user interface rendered by a client according to various embodiments of the present disclosure.

FIG. 5 is a pictorial diagram of an example user interface rendered by a client according to various embodiments of the present disclosure.

FIG. 6 is a pictorial diagram of an example user interface rendered by a client according to various embodiments of the present disclosure.

FIG. 7 is a drawing of a networked environment according to various embodiments of the present disclosure.

FIG. 8 is a flowchart illustrating one example of functionality implemented as portions of an application executed in a computing environment in the networked environment of FIG. 7 according to various embodiments of the present disclosure.

FIG. 9 is a flowchart illustrating one example of functionality implemented as portions of an application executed in a computing environment in the networked environment of FIG. 7 according to various embodiments of the present disclosure.

FIG. 10 is a schematic block diagram that provides one example illustration of a computing environment employed in the networked environment of FIG. 7 according to various embodiments of the present disclosure.

### SUMMARY

Disclosed are various embodiments of a system that includes a computing device comprising a processor and a memory; and machine readable instructions stored in the memory that, when executed by the processor, cause the computing device to at least receive a first media file from a client device; identify an object in first media file; execute a search for a second media file associated with the object in the first media file; and send the second media file to the client device. In some embodiments, the machine readable instructions that cause the computing device to identify the object in the first media file further cause the computing device to at least identify a first point cloud corresponding to the object; compare the first point cloud to a second point cloud stored in an object record; and determine that the object in the first media file matches the object record based at least in part on a similarity of the first point cloud to the second point cloud. In some embodiments, the machine readable instructions that cause the computing device to execute the search for the second media file associated with the object in the first media file further cause the computing device to at least retrieve a first object identifier from an object record associated with the object in the first media file; and determine that the first object identifier matches a second object identifier linked to the second media file. In some embodiments, the machine readable instructions, when executed by the processor, further cause the computing device to at least identify a user account associated with the client device; and determine that the user account is included in a group of user permitted to access the second media file. In some embodiments, the first media file includes at least one of an image file or a video file. In some embodiments, the second media file includes at least one of an image file or a video file. In some embodiments, the second media file comprises a text file.

Disclosed are various embodiments for a computer-implemented method, including receiving a first media file from a client device; identifying an object in first media file; executing a search for a second media file associated with the object in the first media file; and sending the second media file to the client device. In some embodiments, identifying the object in the first media file further includes identifying a first point cloud corresponding to the object; comparing the first point cloud to a second point cloud stored in an object record; and determining that the object in the first media file matches the object record based at least in part on a similarity of the first point cloud to the second point cloud. In some embodiments, executing the search for the second media file associated with the object in the first media file further includes retrieving a first object identifier from an object record associated with the object in the first media file; and determining that the first object identifier matches a second object identifier linked to the second media file. Some embodiments further include identifying a user account associated with the client device; and determining that the user account is included in a group of users permitted to access the second media file. In some embodiments, the first media file includes at least one of an image file or a video file. In some embodiments, the second media file includes at least one of an image file or a video file. In some embodiments, the second media file includes a text file.

Disclosed are various embodiments of a non-transitory computer-readable medium storing machine readable instructions that, when executed by a processor of a computing device, cause the computing device to at least receive a first media file from a client device; identify an object in first media file; execute a search for a second media file associated with the object in the first media file; and send the second media file to the client device. In some embodiments, the machine readable instructions that cause the computing device to identify the object in the first media file further cause the computing device to at least identify a first point cloud corresponding to the object; compare the first point cloud to a second point cloud stored in an object record; and determine that the object in the first media file matches the object record based at least in part on a similarity of the first point cloud to the second point cloud. In some embodiments, the machine readable instructions that cause the computing device to execute the search for the second media file associated with the object in the first media file further cause the computing device to at least retrieve a first object identifier from an object record associated with the object in the first media file; and determine that the first object identifier matches a second object identifier linked to the second media file. In some embodiments, the machine readable instructions, when executed by the processor, further cause the computing device to at least identify a user account associated with the client device; and determine that the user account is included in a group of user permitted to access the second media file. In some embodiments, the first media file includes at least one of an image file or a video file. In some embodiments, the second media file includes at least one of an image file or a video file.

### DETAILED DESCRIPTION

Disclosed are various embodiments related to searching for media files or data streams based at least in part on a physical object contained within the media file and sharing one or more media files that include the physical object. Users may take a photograph or capture a video that includes a physical object. Users can then select the physical object to initiate search for available media files or data streams (e.g., images, video, text, etc.) related to the selected physical object. For example, if a user took a picture of a can of “Lemon-Lime Soda,” then any media files or data streams related to “Lemon-Lime Soda” would be returned to the user. Likewise, a user could link or associate (e.g., “tag”) the captured image or video with the “Lemon-Lime Soda” object, thereby allowing the user's captured image or video to be surfaced to other users that may use their own images or videos to search for media files related to “Lemon-Lime Soda.” In the following discussion, a general description of the system and its components is provided, followed by a discussion of the operation of the same.

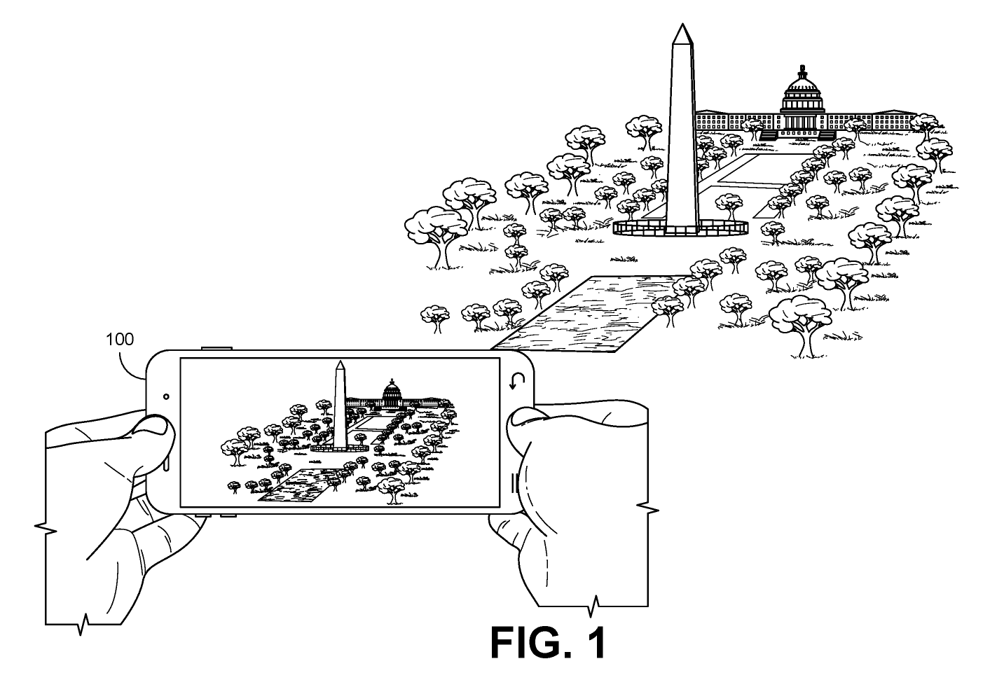

As illustrated in FIG. 1, a user can use a client device 100 to generate a first media file. The first media file or data stream can correspond to an image, a video, or other type of media. In some instances, the first media file or data stream may be sent to a remote computing device for further processing automatically after the first media file or data stream has been generated. In various instances, the user may also have the option to manually send the first media file to a remote computing device for further processing.

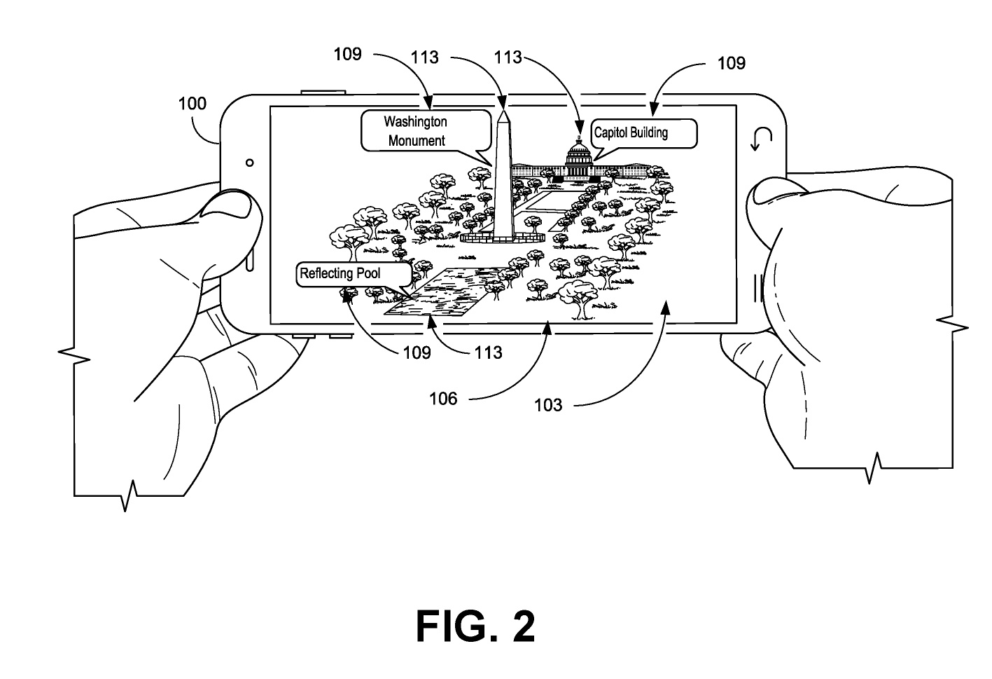

FIG. 2 illustrates a user interface 103 generated on the display 106 of the client device 100. Here, one or more user interface elements 109 (e.g., balloons, hyperlinks, buttons, or other user interface elements) are displayed identifying various objects 113 present within the first media file previously captured in FIG. 1. In some instances, the first media file or data stream may have been sent to a remote computing device for the objects 113 to be identified. In these instances, the remote computing device would return a response that included the identity of each object 113 identified. The client device 100 could then cause the user interface elements 109 to be rendered next to each identified object 113.

However, other embodiments of the present disclosure may present the identities of the individual objects 113 to the user in other ways. For example, in some instances, identified objects 113 may be highlighted within the user interface 103. If the user selects or manipulates the highlighted object 113 (e.g., presses, clicks, touches, or drags the object 113), then the user could be presented with additional information about the object 113, such as its identity. This information could be presented in a new window, in an overlay, in a pop-over window, or through various other approaches. Other embodiments of the present disclosure may present the identity of individual objects 113 in the first media file to the user using other approaches.

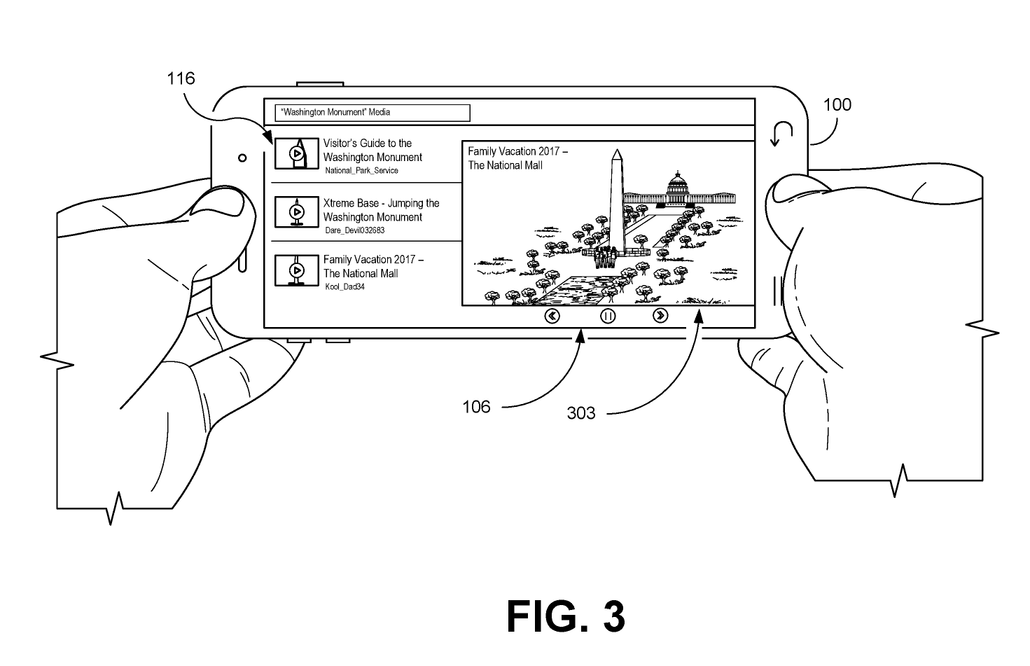

FIG. 3 demonstrates an example user interface 303 that may be presented on the display 106 of the client device 100 in response to a user selecting an object 113 (FIG. 2) marked as identified in FIG. 2. For example, if the user had pressed the user interface element 109 (FIG. 2) identifying the “Washington Monument” or the Washington Monument itself, depending on the particular implementation of the present disclosure, the user could be presented with the user interface 303 depicted in FIG. 3. Here, the user interface 303 includes several media files 116 that have been identified as being related to the selected object 113 (e.g., the “Washington Monument”). These related media files 116 may have been selected because they included the Washington Monument (e.g., other videos or images), because they had been identified by other users as being related to the Washington Monument (e.g., an author tagging his or her book as being about the history of the Washington Monument), or because they satisfied other criteria. In some embodiments, access to one or more of the media files 116 may be restricted (e.g., the media files 116 may be hidden or excluded from presentation within the user interface 303) based on various criteria, such as permissions specified by the user that created the second media file 116.

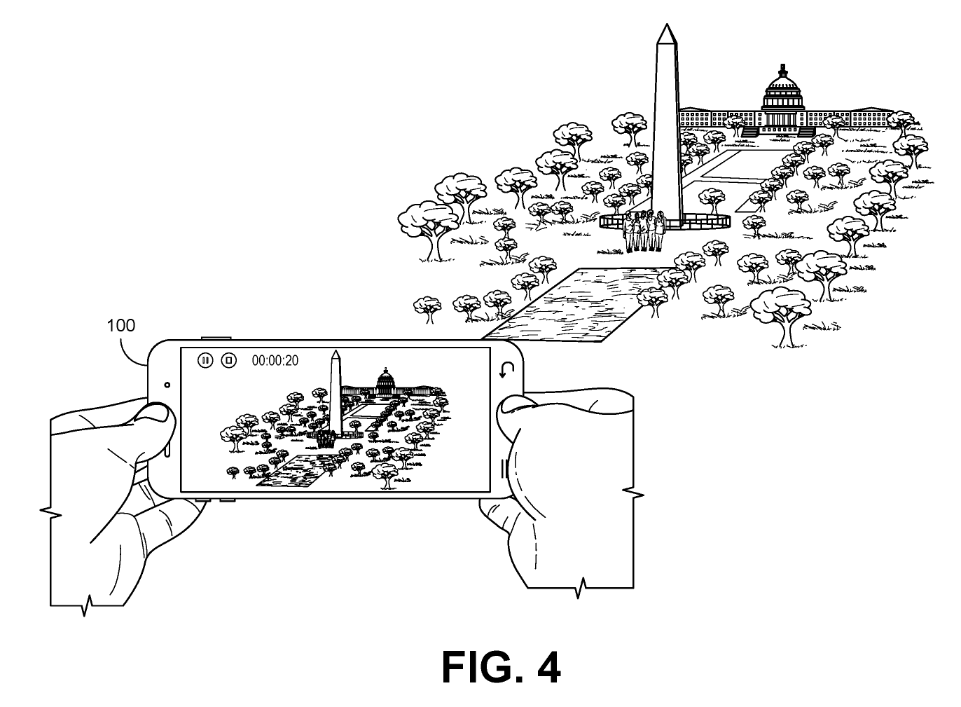

FIG. 4 illustrates an example of a user of a client device 100 generating a media file, such as a video, containing multiple objects. In the illustrated example, the user is capturing a video of a group of people in front of the Washington Monument. However, the client device 100 could be used to generate any media file that included an object (e.g., image of a can of soda, image of a page of a book, video of an animal at the zoo, etc.).

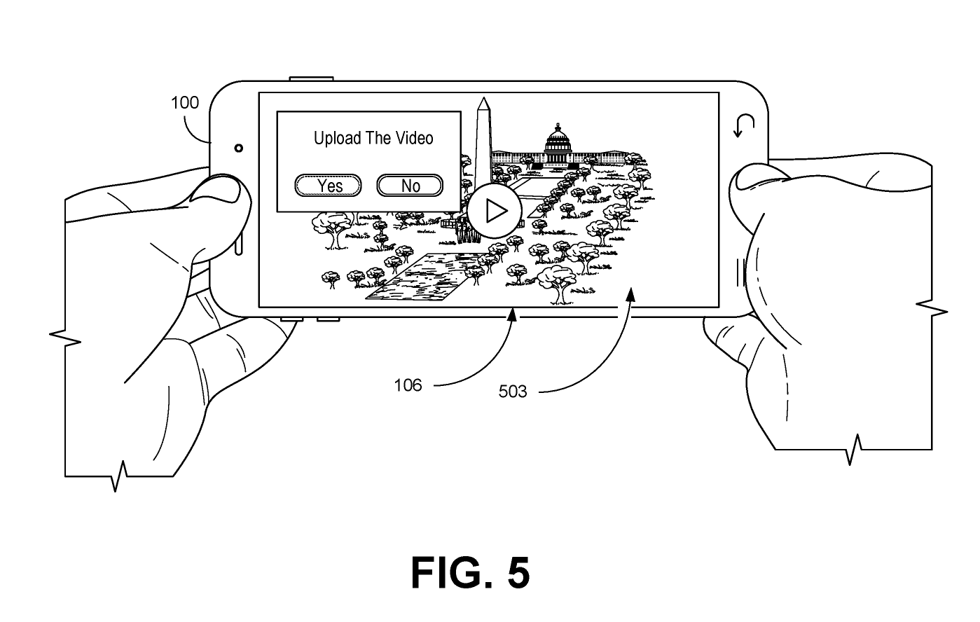

FIG. 5 illustrates an example user interface 503 depicted on the display 106 of the client device 100 that allow for a user to upload or save the generated media file 116 to a remote computing device. In some instances, the user interface 103 allowing for a user to upload a media file 116 to the remote computing device may be built into the same application that allows the user to generate the media file (e.g., the application that captures the image or video). In other instances, the user interface 103 that allows the user to upload the media file may be part of a separate application or component, such as a file management tool that allows a user to select and upload media files.

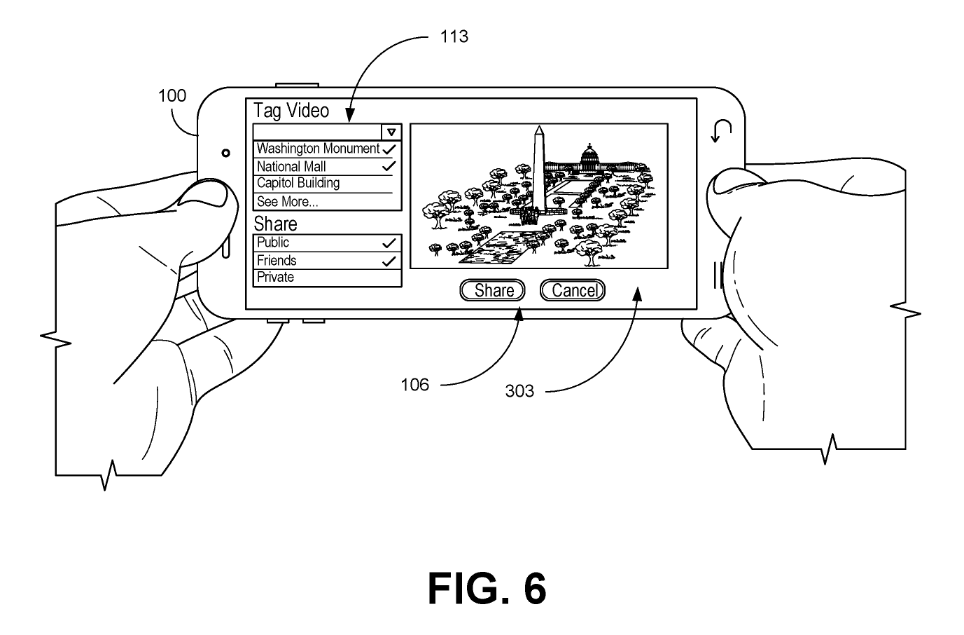

FIG. 6 illustrates an example user interface 603 that may be presented on the display 106 of the client device 100 in response to a user selecting in FIG. 5 to upload the media file 116 to the remote computing device. As depicted, the user can “tag” or otherwise link the media file with one or more objects 113 that have been automatically identified by the remote computing device as being present in the media file. A user can also specify various permissions related to the media file, such as listing groups of users with whom the media file may be shared.

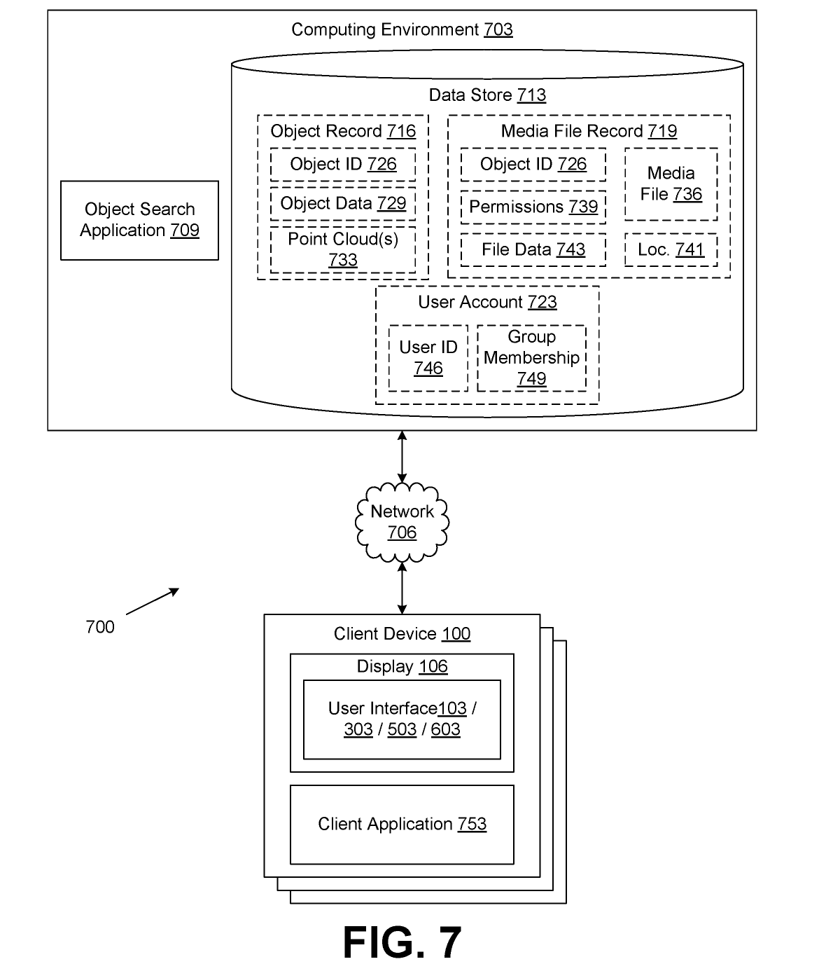

With reference to FIG. 7, shown is a networked environment 700 according to various embodiments. The networked environment 700 includes a computing environment 703 and a client device 100, which are in data communication with each other via a network 706. The network 706 includes wide area networks (WANs) and local area networks (LANs). These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 706 can also include a combination of two or more networks 706. Examples of networks 706 can include the Internet, intranets, extranets, virtual private networks (VPNs), and similar networks.

The computing environment 703 may include, for example, a server computer or any other system providing computing capability. Alternatively, the computing environment 703 may employ a plurality of computing devices that may be arranged, for example, in one or more server banks or computer banks or other arrangements. Such computing devices may be located in a single installation or may be distributed among many different geographical locations. For example, the computing environment 703 may include a plurality of computing devices that together may include a hosted computing resource, a grid computing resource or any other distributed computing arrangement. In some cases, the computing environment 703 may correspond to an elastic computing resource where the allotted capacity of processing, network, storage, or other computing-related resources may vary over time.

Various applications or other functionality may be executed in the computing environment 703 according to various embodiments. The components executed on the computing environment 703, for example, include an object search application 709, and other applications, services, processes, systems, engines, or functionality not discussed in detail herein.

The object search application 709 is executed to identify objects 113 (FIG. 2) in image or video files and search for files related to the identified objects. Accordingly, the object search application 709 may rely on various computer vision and object identification techniques to identify unique objects 113 in an image or video file. The object search application 709 may then search for related files using one or more of the various techniques further described herein. The object search application 709 may also be configured, in some embodiments, to allow users to upload files to the data store 713, link the file to one or more objects 113, and set various permissions identifying which other users are permitted to view, consume, or otherwise access the uploaded file.

Various data is stored in a data store 713 that is accessible to the computing environment 703. The data store 713 may be representative of a plurality of data stores 713, which can include relational databases, object-oriented databases, hierarchical databases, hash tables or similar key-value data stores, as well as other data storage applications or data structures. The data stored in the data store 713 is associated with the operation of the various applications or functional entities described below. This data can include object records 716, media file records 719, user accounts 723, and potentially other data.

The object record 716 represents information that is related to or describes an object 113. Accordingly, the object record 716 can include an object identifier 726, object data 729, and one or more point clouds 733. Other data may also be stored in the object record 716 as required by various embodiments of the present disclosure.

The object identifier 726 corresponds to a primary key that allows the object record 716 to be uniquely identified in the data store 713 by the object search application 709. An example of an object identifiers 726 would include a numeric identifier generated when the object record 716 is initially created. If sequential numbers were used, this would allow for the each object record 716 to have a unique object identifier 726.

The object data 729 represents information about the object 113. Object data 729 can include, for example, the name of the object 113, the owner of the object 113 (e.g., property owner), notes or facts about the object 113, the price of the object 113 (e.g., consumer goods), ratings or reviews of the object 113 (e.g., ratings of goods by other users), and any other data appropriate for the particular object 113 corresponding to the object record 716. Object data 729 may be added to the object record 716 when the object record 716 is first created, or it may be updated by one or more users at a later point in time. In some embodiments, limits may be placed on which user accounts 723 are allowed to modify the object data 729.

The point clouds 733 represent collections of points that define the shape or contour of an object 113. Multiple point clouds 733 may be stored within an object record 716 to represent different views of the same object 113 (e.g., views from different angles or perspectives). The object search application 709 can use a point cloud 733 stored in an object record 716 to determine whether an object 113 in an image or video is the same as an object 113 corresponding to the object record 716.

The media file record 719 represents information that is related to or describes a media file 736 related to an object record 716 for a particular object 113. The media file 736 can represent either a discrete file, a data stream, or a combination thereof. Accordingly, references to the term media file 736 can include references to a file, a data stream, or a combination thereof as may be appropriate for a particular implementation. The media file record 719 can include an object identifier 726 for the corresponding object record 716 of each object 113 identified as present in the media file 736. Accordingly, if multiple objects 113 are identified as present in the media file 736, then multiple object identifiers 726 may be stored as part of the media file record 719. The media file record 719 may also include one or more permissions 739, one or more locations 741 linked to or associated with the media file 736, and file data 743.

The permissions 739 of the media file record 719 define which user accounts 723 are permitted to access or interact with the media file 736 and the manner in which access or interaction is permitted. For example, the permissions 739 may specify which user accounts 723 are allowed to view or consume the media file 736, which user accounts 723 are allowed to modify the media file 736, which user accounts 723 are allowed to remove or delete the medial file 736 and/or the corresponding media record 719. Other permissions 739 may also be specified as appropriate for particular embodiments of the present disclosure. In some instances, the permissions 739 may be applied to individual user accounts 723 or groups of user accounts 723 (e.g., a “Public” or “Everybody” group encompassing all users, a “family” group comprising user accounts 723 belonging to a group of users that are members of the same family, etc.).

The location 741 can represent information geographic information about the media file record 719. For example, the location 741 can be used to store information about where the media file 736 was created, a location 741 to be associated with a media file 736 (e.g., associating the city of Washington, D.C. with a media file 736 depicting the Washington Monument), or similar information. One or more locations 741 can also be stored in the media file record 719. For example, a media file record 719 could include the actual coordinates for the Washington Monument, the geohash or geocode representing the National Mall, and a geohash or geocode representing the city of Washington, D.C. itself.

File data 743 represents metadata about the media file 736 itself. Such metadata can include the name of the media file 736, the type of file (e.g., image, video, etc.), the format of the media file 736 (e.g., MPEG-4 video encoding, JPEG image, etc.), the size of the media file 736, the date the media file 736 was created, the date the media file 736 was last modified, or the date that the media file 736 was uploaded. Other information may also be stored within the file data 743 as may be appropriate for particular embodiments of the present disclosure.

User accounts 723 represent individual users of the object search application 709. Each user account 723 may generally correspond to one user (e.g., an individual or an organization), although a user may have multiple user accounts 723 (e.g., a personal and a professional account). Accordingly, a user account 723 may include a user identifier 746, information about the group membership 749 of the user account 723, and potentially other information.

The user identifier 746 represents a unique identifier that allows for a user account 723 to be distinguished from other user accounts 723. In some implementations, this may correspond to a username selected by a user when the user account 723 is first created. In other implementations, the user identifier 746 may be automatically generated (e.g., a sequential number). In some implementations, multiple user identifiers 746 may be used for efficiency purposes. For example, some implementations may rely on a username to represent the user account 723 to other users while using an automatically assigned number when checking for applicable permissions 739 to increase the speed of the check by relying on simpler integer operations of the computing device.

The group membership 749 lists all of the groups of user accounts 723 for which the specific user account 723 is a member. A user account 723 may belong to one, none, or multiple groups, each of which may be granted various permissions.

The client device 100 is representative of a plurality of client devices that may be coupled to the network 706. The client device 100 may include, for example, a processor-based system such as a computer system. Such a computer system may be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 may include one or more displays 106, such as liquid crystal displays (LCDs), gas plasma-based flat panel displays, organic light emitting diode (OLED) displays, electrophoretic ink (“E-ink”) displays, projectors, or other types of display devices. In some instances, the display 106 may be a component of the client device 100 or may be connected to the client device 100 through a wired or wireless connection.

The client device 100 may be configured to execute various applications such as a client application 753 or other applications. The client application 753 may be executed in a client device 100, for example, to send one or more media files 736 to the object search application 709 to initiate a search for related media files 736 or to add the media file 736 to a media file record 719 in the data store 713. To this end, the client application 753 may include, for example, a browser, a dedicated application, or other executable that can cause a user interface 103/303/503/603 to be rendered on the display 106. The user interface 103/303/503/603 may include a network page, an application screen, or other user mechanism for obtaining user input or presenting output to the user. The client device 100 may be configured to execute applications beyond the client application 753 such as, for example, email applications, social networking applications, word processors, spreadsheets, or other applications.

Next, a general description of the operation of the various components of the networked environment 700 is provided. It should be noted that this general description is meant to serve to illustrate the principals of the present disclosure. One or more features described in this general description may or may not be present in any particular embodiment of the present disclosure.

To begin, a user may capture an image or video of an object 113 and save the captured image or video as a media file 736. In some instances, the location 741 may where the media file 736 was created may also be recorded. For example, the user may use the client application 753 to cause his or her mobile device to capture an image of a soda can. The client application 753 may then prompt the user to upload the media file 736 and save it to the data store 713. Assuming the user chose to upload the media file 736, the client application 753 then sends the media file to the object search application 709.

The object search application 709 then uses one or more computer vision techniques to recognize individual objects 113 within the media file 736 and generate a corresponding point cloud 733 for each identified object 113. The object search application 709 then searches the object records 716 within the data store 713 to determine whether any object records 716 include a point cloud 733 that matches one or more of the point clouds 733 generated from the media file 736. The object search application 709 can then send object data 729 and the object identifier 726 for each matching object record 716 to the client application 753. If one or more point clouds 733 generated from the media file 736 could not be matched to an existing object record 719, the object search application 709 may indicate to the client application 753 that these objects 113 could not be identified.

The client application 753 can then prompt the user to select which objects 113 to associate with the media file 736. The client application 753 may also prompt the user to identify any unidentified objects 113 and provide as much information as possible about the unidentified objects 113. Once the user has made his or her selections, this data is passed back to the object search application 709, which creates a media file record 719 that includes the media file 736 provided by the user, object identifiers 726 for each object record 716 of an object 113 to be associated with the media file 736, and any other information provided by the user (e.g., permissions 739 for the media file 736).

Subsequently, the object search application 709 may receive another media file 736 from the client application 753 to use as the basis for a search. For example, the client application 753 may provide a media file 736 and an indication that the user wishes to search for a second media file 736 linked to an object 113 within the first media file 736 provided by the client application 753. In response, the object search application 709 will generate a point cloud 733 representing the object 113 within the first media file 736, search for an object record 716 containing a matching point cloud 733, and return as a search result any media files 736 containing an object identifier 726 matching the object identifier 726 of the object record 716. If multiple objects 113 are identified within first media file 736, the object search application 709 may send a response to the client application 753 containing a list of identified objects 113 and requesting that the client application 753 prompt the user to select an object 113 to use as the basis of the search.

The matching media files 736 may then be presented to the user by the client application 753. For example, the client application 753 may present several of the media files 736 in a list on the display 106 and prompt the user to select one to consume (e.g., select a video to play, an image to view, or text content to read). In some instances, the location 741 associated with individual media files 736 can be used to filter search results. For example, media file records 719 with a location 741 within a predefined distance of the current location of a client device 100 could be presented at the top of the list of search results. As another example, only media file records 719 within a predefined distance of the current location of the client device 100 might be returned in response to a search.

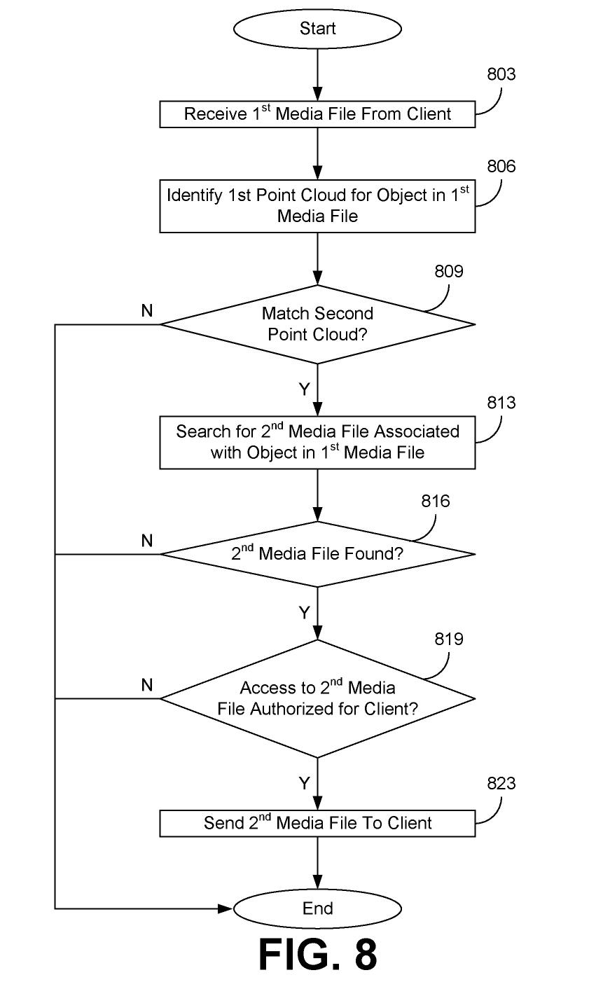

Referring next to FIG. 8, shown is a flowchart that provides one example of the operation of a portion of the object search application 709 according to various embodiments. It is understood that the flowchart of FIG. 8 provides merely an example of the many different types of functional arrangements that may be employed to implement the operation of the portion of the object search application 709 as described herein. As an alternative, the flowchart of FIG. 8 may be viewed as depicting an example of elements of a method implemented in the computing environment 703 (FIG. 7) according to one or more embodiments.

Beginning with box 803, the object search application 709 receives a first media file 736 (FIG. 7) from a client device 100 (FIG. 7). For example, a client application 753 executing on the client device 100 may make use of one or more functions made available by the object search application 709 through an application programming interface (API) to upload the first media file 736 to the object search application 709.

Proceeding to box 806, the object search application 709 uses one or more computer vision techniques to identify individual objects 113 within the first media file 736. For example, the object search application 709 may use various feature detection approaches such as edge detection, corner detection, blob detection, ridge detection, affine invariant feature detection, or similar approaches to identify a collection of features that define an object. This collection of features could include a point cloud 733, a collection of edges, a collection of corners, or similar grouping of features that can be used to uniquely identify the object 113 from other objects 113 in the first media file 736.

Moving on to box 809, the object search application 709 determines whether the collection of features of an object 113 in the first media file 736 matches a collection of features of a known object 113. For example, if the object search application 709 identifies a point cloud 733 of a first object 113, the object search application 709 may determine whether the point cloud 733 matches a second point cloud 733 stored in an object record 716 corresponding to a known object 113. If no match is found, execution ends. However, if a match is found, execution can instead proceed to box 813.

Referring next to box 813, the object search application 709 may search for one or more media files 736 related to the identified object 113. For example, the object search application 709 can determine whether the object identifier 726 of the object record 716 matching the identified object 113 matches the object identifiers 726 stored in any media file records 719. Proceeding next to box 816, the object search application 709 determines whether a second media file 736 related to the object 113 identified in the first media file 736 has been found. If a match is found, then execution can proceed to box 819. Otherwise, execution may end.

Moving on to box 819, the object search application 709 may then check one or more permissions 739 of the media file record 719 to determine whether the client device 100 or a user account 723 (FIG. 7) associated with the client device 100 is allowed to access (e.g., view, edit, share, etc.) the matching media file 736. For example, the object search application 709 may determine whether the client device 100 or the user account 723 associated with the client device 100 is explicitly listed as having permission to access the media file 736. Likewise, the object search application 709 may also check whether the client device 100 or the user account 723 is included in a group of client devices 100 or a group of user accounts 723 that is listed as having permission to access the media file 736. If the client device 100 or the user account 723 associated with the client device 100 or the user account 723 associated with the client device 100 has permission to access the media file 736, then execution proceeds to box 823. Otherwise, execution of the process may end.

Referring next to box 823, the object search application 709 sends the second media file 736 to the client application 753 executing on the client device 100. In some embodiments, execution of this process may end. However, in other embodiments, one or more of the previously described steps may be repeated. For example, portions of the previously described process may be repeated in order for the object search application 709 to search for multiple media files 736 that may be related to the object 113 identified in the first media file 736.

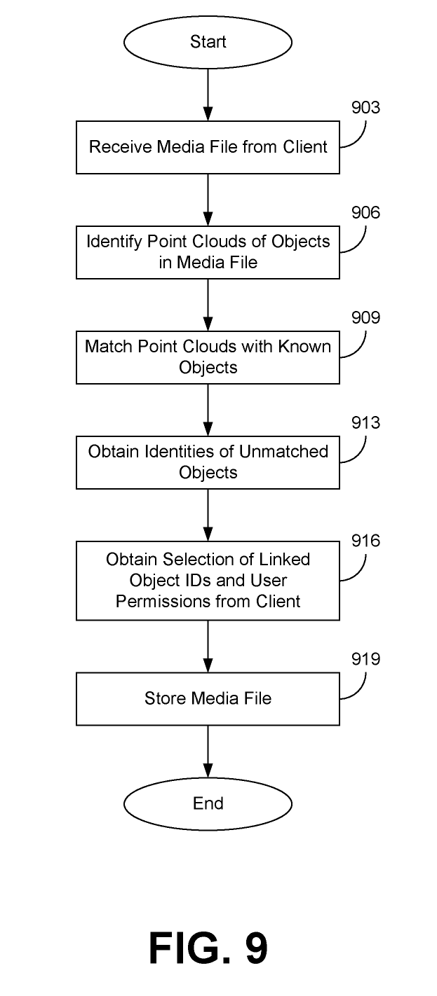

Referring next to FIG. 9, shown is a flowchart that provides one example of the operation of a portion of the object search application 709 according to various embodiments. It is understood that the flowchart of FIG. 9 provides merely an example of the many different types of functional arrangements that may be employed to implement the operation of the portion of the object search application 709 as described herein. As an alternative, the flowchart of FIG. 9 may be viewed as depicting an example of elements of a method implemented in the computing environment 703 (FIG. 7) according to one or more embodiments.

Beginning with box 903, the object search application 709 receives a media file 736 (FIG. 7) from a client device 100 (FIG. 7). For example, a client application 753 executing on the client device 100 may make use of one or more functions made available by the object search application 709 through an application programming interface (API) to upload the media file 736 to the object search application 709.

Proceeding to box 906, the object search application 709 uses one or more computer vision techniques to identify individual objects 113 within the first media file 736. For example, the object search application 709 may use various feature detection approaches such as edge detection, corner detection, blob detection, ridge detection, affine invariant feature detection, or similar approaches to identify a collection of features that define an object. This collection of features could include a point cloud 733, a collection of edges, a collection of corners, or similar grouping of features that can be used to uniquely identify the object 113 from other objects 113 in the first media file 736.

Moving on to box 909, the object search application 709 matches objects 113 previously identified in the media file 736 at box 906 with known objects. For example, the object search application 709 may determine whether the collection of features of an object 113 in the first media file 736 matches a collection of features of a known object 113. For example, if the object search application 709 identifies a point cloud 733 of a first object 113, the object search application 709 may determine whether the point cloud 733 matches a second point cloud 733 stored in an object record 716 corresponding to a known object 113.

Referring next to box 913, the object search application 709 obtains identities of any unknown objects 113. An unknown object 113 can include an object 113 identified in the media file 736 that cannot be matched to an object record 716 for a known or otherwise previously identified object 113. The object search application 709 may obtain the identity of an unknown object in a number of ways. For example, the object search application 709 may send a request to the client application 753 executing on the client device 100 for an identification of the object 113. This request may include information identifying the object 113 within the media file 736 (e.g., a region within an image or a frame of a video that includes the unidentified object 113). This request may cause the client application 753 to prompt the user to identify the object 113 (e.g., enter the name of the object 113 and/or other information known to the user). The client application 753 could then provide the information supplied by the user to the object search application 709 in response to the request received from the object search application 709. The object search application 709 could then create new object records 716 for each newly identified object 113.

Proceeding next to box 916, the object search application 709 obtains information regarding which objects 113 the media file 736 received at box 903 is to be associated with and a list of user accounts 723, groups of user accounts 723, client devices 100, or groups of client devices 100 with which the media file 736 can be shared or otherwise made available. For example, the object search application 709 may send a request for this information to the client application 753, thereby causing the client application 753 to prompt the user to select one or more objects 113 to link with the media file 736 and one or more user accounts 723 or client devices 100 with which to share the media file 736. The object search application 709 may then receive this information from the client application 753 in a response to the request from the object search application 709.

Moving on to box 919, the object search application 709 stores the media file 736. Accordingly, the object search application 709 may create a new media file record 719. The object search application 709 may then store the media file 736 in the media file record 719, object identifiers 726 in the media file record 719 for each object 113 to be associated with the media file 736, and permissions 739 for the user accounts 723 with which the media file 736 may be shared. After the media file 736 is stored, execution of the process may end.

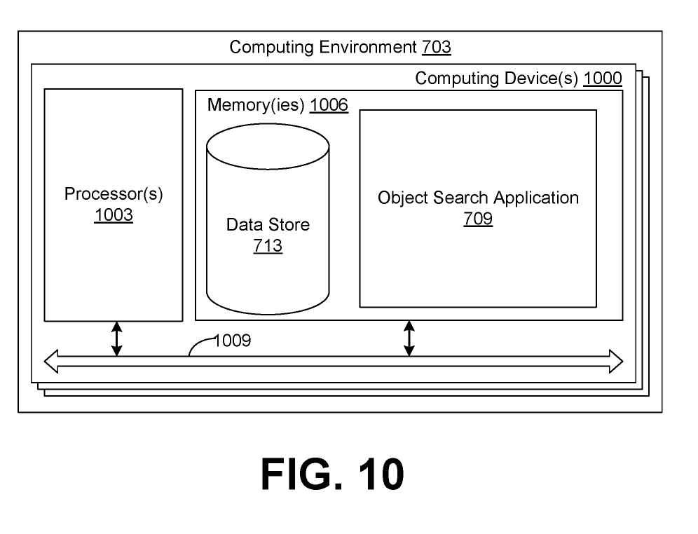

With reference to FIG. 10, shown is a schematic block diagram of the computing environment 703 according to an embodiment of the present disclosure. The computing environment 703 includes one or more computing devices 1000. Each computing device 1000 includes at least one processor circuit, for example, having a processor 1003 and a memory 1006, both of which are coupled to a local interface 1009. To this end, each computing device 1000 may include, for example, at least one server computer or like device. The local interface 1009 may include, for example, a data bus with an accompanying address/control bus or other bus structure as can be appreciated.

Stored in the memory 1006 are both data and several components that are executable by the processor 1003. In particular, stored in the memory 1006 and executable by the processor 1003 is the object search application 709, and potentially other applications. Also stored in the memory 1006 may be a data store 713 and other data. In addition, an operating system may be stored in the memory 1006 and executable by the processor 1003.

It is understood that there may be other applications that are stored in the memory 1006 and are executable by the processor 1003 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 1006 and are executable by the processor 1003. In this respect, the term “executable” means a program file that is in a form that can ultimately be run by the processor 1003. Examples of executable programs may be, for example, a compiled program that can be translated into machine code in a format that can be loaded into a random access portion of the memory 1006 and run by the processor 1003, source code that may be expressed in proper format such as object code that is capable of being loaded into a random access portion of the memory 1006 and executed by the processor 1003, or source code that may be interpreted by another executable program to generate instructions in a random access portion of the memory 1006 to be executed by the processor 1003, etc. An executable program may be stored in any portion or component of the memory 1006 including, for example, random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), or other like memory device.

Also, the processor 1003 may represent multiple processors 1003 or multiple processor cores and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006. The local interface 1009 may include additional systems designed to coordinate this communication, including, for example, performing load balancing. The processor 1003 may be of electrical or of some other available construction.

Although the object search application 709, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 8 and 9 show the functionality and operation of an implementation of portions of the object search application 709. If embodied in software, each block may represent a module, segment, or portion of code that includes program instructions to implement the specified logical function(s). The program instructions may be embodied in the form of source code that includes human-readable statements written in a programming language or machine code that includes numerical instructions recognizable by a suitable execution system such as a processor 1003 in a computer system or other system. The machine code may be converted from the source code through various processes. For example, the machine code may be generated from the source code with a compiler prior to execution of the corresponding application. As another example, the machine code may be generated from the source code concurrently with execution with an interpreter. Other approaches can also be used. If embodied in hardware, each block may represent a circuit or a number of interconnected circuits to implement the specified logical function or functions.

Although the flowcharts of FIGS. 8 and 9 show a specific order of execution, it is understood that the order of execution may differ from that which is depicted. For example, the order of execution of two or more blocks may be scrambled relative to the order shown. Also, two or more blocks shown in succession in FIGS. 8 and 9 may be executed concurrently or with partial concurrence. Further, in some embodiments, one or more of the blocks shown in FIGS. 8 and 9 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the object search application 709, that includes software or code can be embodied in any non-transitory computer-readable medium for use by or in connection with an instruction execution system such as, for example, a processor 1003 in a computer system or other system. In this sense, the logic may include, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can include any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the object search application 709, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 1000, or in multiple computing devices 1000 in the same computing environment 703.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine readable instructions stored in the memory that, when executed by the processor, cause the computing device to at least:
receive a first media file from a client device;
identify an object in a first media file;
execute a search for a second media file associated with the object in the first media file; and
send the second media file to the client device.

2. The system of claim 1, wherein the machine readable instructions that cause the computing device to identify the object in the first media file further cause the computing device to at least:
identify a first point cloud corresponding to the object;
compare the first point cloud to a second point cloud stored in an object record; and
determine that the object in the first media file matches the object record based at least in part on a similarity of the first point cloud to the second point cloud.

3. The system of claim 1, wherein the machine readable instructions that cause the computing device to execute the search for the second media file associated with the object in the first media file further cause the computing device to at least:
retrieve a first object identifier from an object record associated with the object in the first media file; and
determine that the first object identifier matches a second object identifier linked to the second media file.

4. The system of claim 1, wherein the machine readable instructions, when executed by the processor, further cause the computing device to at least:
identify a user account associated with the client device; and
determine that the user account is included in a group of user permitted to access the second media file.

5. The system of claim 1, wherein the first media file comprises at least one of an image file or a video file.

6. The system of claim 1, wherein the second media file comprises at least one of an image file or a video file.

7. The system of claim 1, wherein the second media file comprises a text file.

8. A computer-implemented method, comprising:
receiving a first media file from a client device;
identifying an object in a first media file;
executing a search for a second media file associated with the object in the first media file; and
sending the second media file to the client device.

9. The computer-implemented method of claim 8, wherein identifying the object in the first media file further comprises:
identifying a first point cloud corresponding to the object;
comparing the first point cloud to a second point cloud stored in an object record; and
determining that the object in the first media file matches the object record based at least in part on a similarity of the first point cloud to the second point cloud.

10. The computer-implemented method of claim 8, wherein executing the search for the second media file associated with the object in the first media file further comprises:
retrieving a first object identifier from an object record associated with the object in the first media file; and
determining that the first object identifier matches a second object identifier linked to the second media file.

11. The computer-implemented method of claim 8, further comprising:
identifying a user account associated with the client device; and
determining that the user account is included in a group of users permitted to access the second media file.

12. The computer-implemented method of claim 8, wherein the first media file comprises at least one of an image file or a video file.

13. The computer-implemented method of claim 8, wherein the second media file comprises at least one of an image file or a video file.

14. The computer-implemented method of claim 8, wherein the second media file comprises a text file.

15. A non-transitory computer-readable medium storing machine readable instructions that, when executed by a processor of a computing device, cause the computing device to at least:
receive a first media file from a client device;
identify an object in a first media file;
execute a search for a second media file associated with the object in the first media file; and
send the second media file to the client device.

16. The non-transitory computer-readable medium of claim 15, wherein the machine readable instructions that cause the computing device to identify the object in the first media file further cause the computing device to at least:
identify a first point cloud corresponding to the object;
compare the first point cloud to a second point cloud stored in an object record; and
determine that the object in the first media file matches the object record based at least in part on a similarity of the first point cloud to the second point cloud.

17. The non-transitory computer-readable medium of claim 15, wherein the machine readable instructions that cause the computing device to execute the search for the second media file associated with the object in the first media file further cause the computing device to at least:
retrieve a first object identifier from an object record associated with the object in the first media file; and
determine that the first object identifier matches a second object identifier linked to the second media file.

18. The non-transitory computer-readable medium of claim 15, wherein the machine readable instructions, when executed by the processor, further cause the computing device to at least:
identify a user account associated with the client device; and
determine that the user account is included in a group of users permitted to access the second media file.

19. The non-transitory computer-readable medium of claim 15, wherein the first media file comprises at least one of an image file or a video file.

20. The non-transitory computer-readable medium of claim 15, wherein the second media file comprises at least one of an image file or a video file.
